(19) United States
(12) Patent Application Publication
(10) Pub. No.: US 2019/0393575 A1
(43) Pub. Date: Dec. 26, 2019

(54) BATTERY COOLING AND HEATING DEVICE AND BATTERY INCORPORATING SUCH A DEVICE

(71) Applicant: ZODIAC AERO ELECTRIC, Montreuil (FR)

(72) Inventor: Katib Chabane, Montreuil (FR)

(73) Assignee: ZODIAC AERO ELECTRIC, Montreuil (FR)

(21) Appl. No.: 16/450,713

(22) Filed: Jun. 24, 2019

(30) Foreign Application Priority Data
Jun. 25, 2018 (FR) 1855635

(51) Int. Cl. H01M 10/6555; H01M 10/625

(52) U.S. Cl. CPC H01M 10/6555; H01M 2220/20; H01M 10/625

(57) ABSTRACT

A battery cooling and heating device that includes an assembly of plates made from heat-conducting material that are configured to be positioned between the cells of the battery and a heating member in contact with said assembly of plates made from heat-conducting material.

### BACKGROUND

Today, there are various methods for cooling and heating batteries. As regards cooling, in the field of motor vehicles, batteries can be cooled by means of a hydraulic cooling system, a cooling liquid being circulated around the battery casing.

This type of technology naturally requires the provision of a network for supplying and circulating the cooling liquid, which increases the overall mass of the battery, thus reducing the advantages associated with the use of a lithium-ion battery, with regards to a saving in mass.

Moreover, there are cooling systems based on the use of a fan. Such a solution cannot, however, be used in the aeronautical field in which batteries supplied with a sealed housing are generally used.

As regards heating up the battery, the current solutions are based on the use of cartridge heaters, electronic boards supplied with heating resistors or heating devices mounted on each cell above the battery or on the entire battery.

Yet again, this type of technology is accompanied by an increase in the weight of the battery assembly.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

Aspects of the present disclosure relate to batteries, in particular batteries in the aeronautical field, such as batteries mounted on board aircraft.

More specifically, certain embodiments relate to the cooling and heating of batteries such as to keep them within an acceptable temperature range.

Certain embodiments are specifically used for lithium-ion batteries, which are sensitive to temperature.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a general view of a battery supplied with a cooling and heating device in accordance with the invention; and

FIG. 2 is an exploded view illustrating the positioning of a plate of the cooling device of FIG. 1 between two battery cells.

### DETAILED DESCRIPTION

The present invention relates to batteries, in particular batteries in the aeronautical field, such as batteries mounted on board aircraft.

More specifically, the invention relates to the cooling and heating of batteries such as to keep them within an acceptable temperature range.

The invention is specifically used for lithium-ion batteries, which are sensitive to temperature.

The batteries must, indeed, be cooled in order to avoid any overheating which may lead to thermal runaway that can cause safety problems. This problem is more acute when the batteries are mounted on board an aircraft.

The batteries must also be heated up in order to be able to use them at full power or at a level close to the full power thereof. Indeed, it has been noted that the performances of lithium-ion batteries can drop when the temperature thereof is too low.

For example, they can be used only at 50% of the maximum capacity thereof when the operating temperature thereof is −10° C.

Therefore, the aim of the invention is to overcome these various disadvantages.

Therefore, the subject matter of the invention is a battery cooling and heating device comprising an assembly of plates made from heat-conducting material that are configured to be positioned between the cells of the battery and a heating member, said device being provided with fixing means for mounting the heating member in contact with said assembly of plates made from heat-conducting material.

Such a device, with a relatively simple structure, thus makes it possible to cool and heat a battery without a substantial increase in the mass of the battery, calories being transferred using the plates positioned between the cells.

According to another feature, each plate includes folded lateral sides with a width corresponding substantially to the space between two cells.

Each plate can include a folded lower or upper side intended to receive the heating member.

Advantageously, the device comprises two folded mutually opposite lateral sides supplied with gas-release holes.

A heat sink can also be provided to bear on the folded mutually opposite lateral sides.

For example, the heating member includes a board supplied with heating tracks.

Another subject matter of the invention is a battery comprising an assembly of battery cells and a device for cooling and heating the battery, this cooling and heating device including an assembly of plates made from heat-conducting material which are each arranged between two cells of the battery in a heat exchange relationship with the outside of the battery and a heating member mounted in contact with said assembly of plates.

The battery can further include a housing at least partially surrounding the cells.

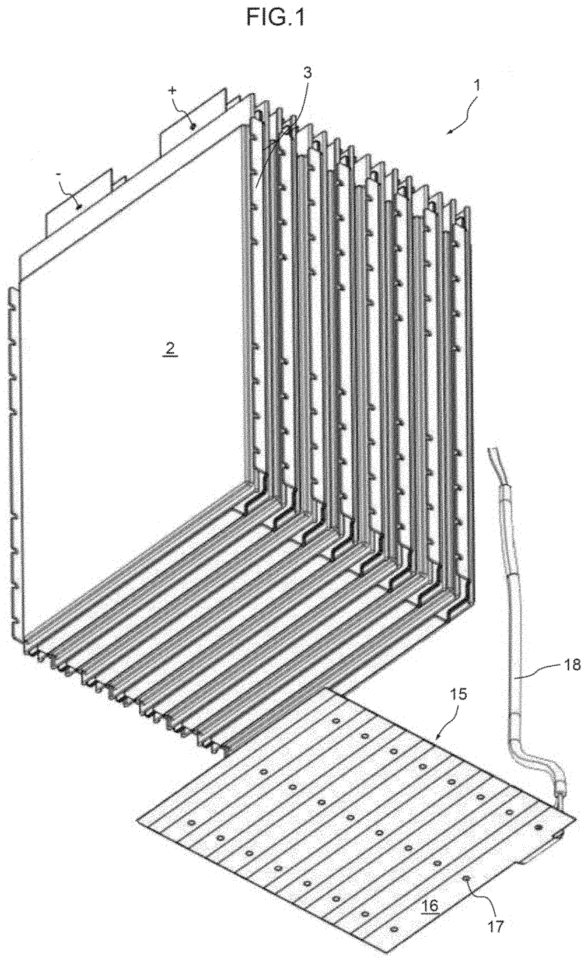

FIG. 1 shows the structure of a battery in accordance with the invention, in this case a battery intended to be mounted on board an aircraft.

This battery is shown in a vertical position of use. The orientation of the battery as illustrated is however not limiting such that the battery lower side facing the bottom of FIG. 1 can form the battery upper side.

This battery, designated by the general reference 1, only a main part of which is illustrated, is advantageously formed from conventional lithium-ion cells, like 2, of which there are sixteen in this case, for example. The cells have a planar structure and are placed side-by-side in parallel while being spaced from one another.

The battery 1 further includes a cooling and heating device used for cooling the cells and for the heating thereof in order to keep them within a permitted-operation temperature range, for example between 0° C. and 55° C.

The assembly is placed in a housing, not shown, which is sealed for example.

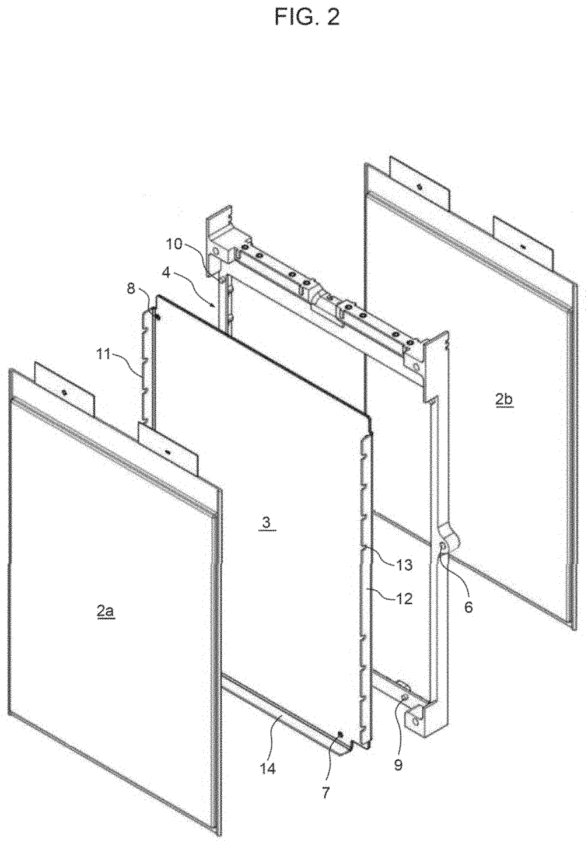

As can be seen, the cooling and heating device includes an assembly of plates made from heat-conducting material, like plates 3, which are each placed between two cells, such as 2a and 2b of the battery (FIG. 2), in a heat exchange relationship with the outside of the battery.

For example, the plates 3 are each produced from a metal suitable for the envisaged use, for example aluminum or copper when it is necessary to evacuate the heat more quickly.

The plates 3 each have a shape that is complementary to that of the cells such as to be positioned opposite and in a heat exchange relationship with regard to a substantial part, or even the entirety, of the large faces of the cells 2.

For example, as shown, the cells 2 and the plates 3 of the cooling and heating device have a square shape.

As can be seen, the plates 3 are each mounted on a support frame 4 supplied with holes for fixing, such as 6, on the battery.

The plates 3 are, in this respect, each supplied with centering holes, 7 and 8, of which there are two in this case, which engage pins 9 and 10 provided on the support frame.

The plates 3 are each supplied with two folded vertical lateral sides 11 and 12 each forming a shoulder extending perpendicular to the plane of the plate. The width of the folds corresponds to the distance between two cells between which the plate is inserted.

The folded lateral sides are supplied with gas-release notches 13.

The lower side 14 of each plate is also folded and likewise forms an edge perpendicular to the plane of the plate. The fold is formed on the rear side of the plate, with regard to the direction for inserting the plate between the battery cells.

The width of the resulting lower fold corresponds to the distance between two plates. The lower fold, by contrast, does not have a notch or a hole in order to maximize the heat exchange surface.

The cooling and heating device is, indeed, completed by a heating member 15 which covers the lower face of the assembly of the cells, bearing against the lower fold.

This heating member includes a printed circuit board 16 supplied with fixing holes 17 used for fixing the board on the support frame 4 and includes tracks forming resistors bearing on the folded lower edge 14 of each plate.

These resistors are powered by a power supply cable 18.

Thus, when it is detected that the operating temperature of the battery is too low, the heating member is powered and the calories recovered by the folded edge 14 of the plates 3 are transmitted by the plates to the cells 2.

The cells are also cooled by heat conduction and the recovered calories are evacuated thanks to the thermal inertia of the plates.

The thermal inertia can be increased by optionally adding a sink in contact with the folded lateral sides 11 and 12 of the plates.

While illustrative embodiments have been illustrated and described, it will be appreciated that various changes can be made therein without departing from the spirit and scope of the invention.

The embodiments of the invention in which an exclusive property or privilege is claimed are defined as follows:

1. A battery cooling and heating device, characterized in that it includes an assembly of plates made from heat-conducting material that are configured to be positioned between the cells of the battery and a heating member in contact with said assembly of plates made from heat-conducting material.

2. The device according to claim 1, wherein each plate includes folded lateral sides with a width corresponding substantially to the space between two cells.

3. The device according to claim 2, wherein each plate includes a folded lower or upper side intended to receive the heating member.

4. The device according to claim 2, comprising two folded mutually opposite lateral sides supplied with gas-release holes.

5. The device according to claim 4, further comprising a heat sink bearing on the folded mutually opposite lateral sides.

6. The device according to claim 1, wherein the heating member includes a board supplied with heating tracks.

7. A battery comprising an assembly of battery cells and a device for cooling and heating the battery, characterized in that the cooling and heating device includes an assembly of plates made from heat-conducting material which are each arranged between two cells of the battery in a heat exchange relationship with the outside of the battery and a heating member mounted in contact with said assembly of plates.

8. The battery according to claim 7, further comprising a housing at least partially surrounding the cells.
